(19) United States
(12) Patent Application Publication
(10) Pub. No.: US 2025/0370469 A1
(43) Pub. Date: Dec. 4, 2025

(54) Method for Optimizing a Geometric Path for a Robot Device Around an Obstacle

(71) Applicant: ABB Schweiz AG, Baden (CH)

(72) Inventors: Nima Enayati, Mannheim (DE); Morten Akerblad, Västerås (SE); Arne Wahrburg, Weiterstadt (DE); Mikael Norrlof, Norrköping (SE); Mattias Bjorkman, Västerås (SE); Rene Kirsten, Fernwald (DE); Giacomo Spampinato, Västerås (SE); Debora Clever, Zwingenberg (DE); Florian Stuhlenmiller, Ladenburg (DE)

(73) Assignee: ABB Schweiz AG, Baden (CH)

(21) Appl. No.: 19/303,564

(22) Filed: Aug. 19, 2025

Related U.S. Application Data
(63) Continuation of application No. PCT/EP2023/054285, filed on Feb. 21, 2023.

(51) Int. Cl. G05D 1/622

(52) U.S. Cl. CPC G05D 1/622

(57) ABSTRACT

A method for optimizing a geometric path for a robot device around an obstacle includes providing the geometric path having a target position point at an intersection of first and second segments; defining a blending zone around the target position point, wherein the blending zone is a curve blending the first segment into the second segment; and optimizing the size of the blending zone by shifting the start point along the first segment and the end point along the second segment to find an optimal blending zone of the at least first blending zone that corresponds to a best cost function according to a defined criterion between the curve start point of the first segment and the curve end point of the second segment on the geometric path, wherein the optimal blending zone of the at least first blending zone satisfies at least one predefined condition.

### CROSS-REFERENCE TO RELATED APPLICATIONS

The instant application claims priority to International Patent Application No. PCT/EP2023/054285, filed Feb. 21, 2023, which is incorporated herein in its entirety by reference.

### FIELD OF THE DISCLOSURE

The present disclosure generally relates to a method for optimizing a geometric path for a robot device around an obstacle.

### BACKGROUND OF THE INVENTION

In a non-productive motion of a robot device its geometric path is typically not required to follow a pre-defined geometry. Such a path may consist of several so-called via points, which are often defined by the user such that the robot device moves between or along productive sections of a task, while not colliding with itself or the rest of the cell. By not forcing the robot device to stop at via points, and rather take a shortcut, the motion can become shorter and smoother resulting in reduced motion time and less stress on the robot. Such shortcuts are defined by a blending zone parameter for a given target that specifies for instance the maximum distance that the TCP (=Tool center point) of the robot can deviate from the target. With a larger blending zone parameter, the path of the robot device can become smoother and shorter.

However, currently in the prior art, the user often needs to perform a trial-and-error approach for all via points to find an optimal blending zone parameter that is large but does not lead to a collision. This is usually done by moving the robot device in a simulation or in the real world along a potential geometric path to check if the resulting geometric path leads to a collision. The existing approach often results in the user selecting a smaller zone for all the via points of a geometric or motion path, thereby unnecessarily limiting the performance and the smoothness of the motion of the robot device.

### BRIEF SUMMARY OF THE INVENTION

The present disclosure generally describes an improved concept of automatically generating the optimal collision-free blending zone parameters for a predefined or given geometric or motion path of a robot device.

In a first aspect, the present disclosure describes a method for optimizing a geometric path for a robot device around an obstacle, the method comprising: providing the geometric path for the robot device, wherein the geometric path comprises at least one target position point for the robot device that is defined as an intersection of a first segment and a second segment forming the geometric path; defining at least a first blending zone around the at least one target position point, wherein the at least first blending zone is defined as a curve of the geometric path that blends the first segment into the second segment, and wherein a size of the curve is defined by a start position of an start point on the first segment of the geometric path and a curve end position of an end point of the second segment of the geometric path; and optimizing the size of the at least first blending zone by shifting the start point along the first segment and the end point along the second segment to find an optimal blending zone of the at least first blending zone that corresponds to a best cost function according to a defined criterion between the curve start point of the first segment and the curve end point of the second segment on the geometric path, wherein the optimal blending zone of the at least first blending zone satisfies at least one predefined condition.

In other words, a core idea behind the present invention is to find automatically the optimal zone parameters for a given set of via points on a predefined geometric path of a robot device, so that a collision-free and optimal motion of the robot device between modelled robot links or attachments and an obstacle is guaranteed along a nominal path of the robot device. These via points can originate from a user program or from an algorithm such as collision-free path planning. The solution requires collision body representation of robot links, robot attachments and obstacles. Collision geometries can be provided for instance as CAD models in simulation software tool or via point-clouds from a perception system.

In the context of the present disclosure, a blending zone is defined by a first segment of the geometric path that blends into a second segment of the geometric path.

The major advantages achieved by this approach are that the optimal collision-free zone parameters for a given path of the robot device can be found automatically. This can significantly reduce motion time and mechanical stress on the robot albeit leaving no effort to the user in dealing with optimizing zone parameters in non-productive motions. By providing an optimal zone for the motion of the robot device, the movements of the robot device can be smoother and consumes less energy and further applies less mechanical stress on the mechanics of the robot device resulting in an extended lifetime and a reduction of service intervals of the robot device.

### BRIEF DESCRIPTION OF THE SEVERAL VIEWS OF THE DRAWING(S)

FIG. 1 is a schematic flow-diagram of a method in accordance with the present disclosure.

Each of FIGS. 2a, 2b, 2c, and 2d, illustrates a schematic example of finding an optimal blending zone for a robot device along a given path in an iterative manner according to a method of the present disclosure.

### DETAILED DESCRIPTION OF THE INVENTION

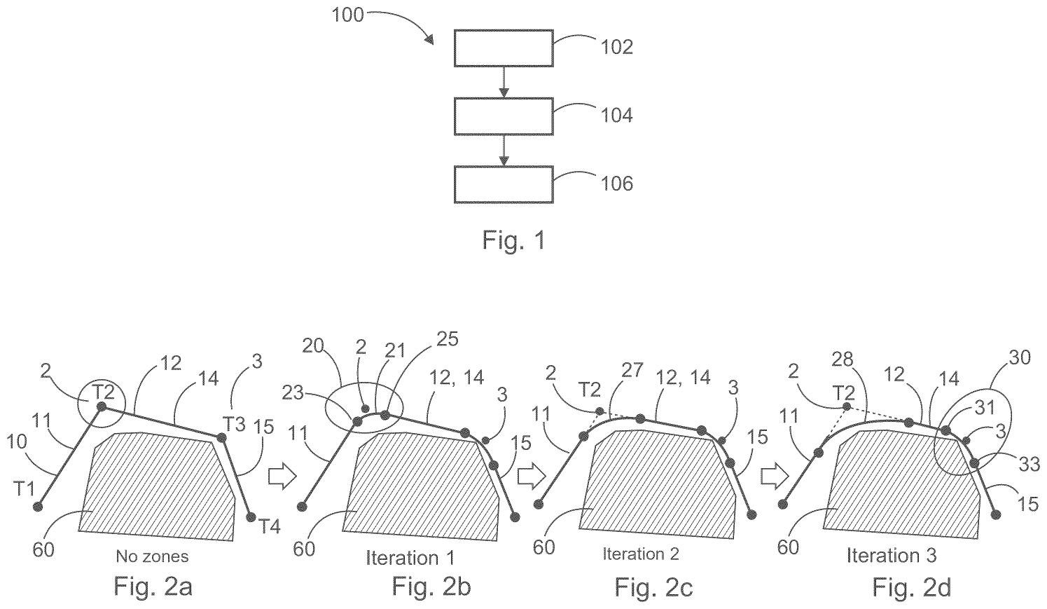

FIG. 1, in combination with FIG. 2, illustrates a schematic flow-diagram of a method 100 for optimizing a geometric path 10 for a robot device around an obstacle 60, comprising the following steps of the present invention.

In a first step 102, a geometric path 10 for the robot device is provided, wherein the geometric path 10 comprises at least one target position point 2 for the robot device that is defined as an intersection of a first segment 11 and a second segment 12 forming the geometric path 10.

In a second step 104, at least a first blending zone 20 around the at least one target position point 2 is defined, wherein the at least first blending zone 20 is defined as a curve 21 of the geometric path 10 that blends the first segment 11 into the second segment 12, and wherein a size of the curve 21 is defined by a start position of an start point 23 on the first segment 11 of the geometric path 10 and a curve end position of an end point 25 of the second segment 12 of the geometric path 10.

Shifting of the start point 23 and the end point 25 change the shape of the curve 21. The curve 21 is not necessarily a circular curve. The at least first blending zone 20 is a non-liner function that generates a curve either in joint space or the Cartesian space.

In a third step 106, the size of the at least first blending zone 20 is optimized by shifting the start point 23 along the first segment 11 and the end point 25 along the second segment 12 to find an optimal blending zone of the at least first blending zone 20 that corresponds to a best cost function according to a defined criterion between the curve start point 23 of the first segment 11 and the curve end point 25 of the second segment 12 on the geometric path 10, wherein the optimal blending zone of the at least first blending zone 20 satisfies at least one predefined condition.

In the context of step 106, it should be further noted that since the robot device is moving continuously through the blending zone 20 and it is a challenge to calculate costs and constraints only in the segment of the at least one blending zone 20 except for the distance), the present invention focuses to automatically find the optimal zone that corresponds to the least cost of motion and that satisfies at least one predefined constraint in the motion or movement of the robot device from the start point 23 of segment 11 to the end point 25 of segment 12.

Preferably, the step 106 of optimizing and finding the optimal blending zone for the robot device is performed in an iterative manner. Preferably, the step 106 of optimizing is performed by a discrete search or a continuous search manner.

The at least first blending zone 20 according to FIG. 2 is a non-linear function that generates a curve in a joint space or in a Cartesian space.

The best cost function according to the defined criterion is a shortest path 28 between the start point 23 and the end point 25. Not limiting examples for such a defined criterion may be a shortest path of the robot device around the obstacle, fastest path of the robot device around the obstacle, least consumed electro-mechanical energy of the robot device around the obstacle, longest robot lifetime of the robot device, least robot tool speed variation of the robot device around the obstacle.

A non-limiting example for the at least predefined condition is at least one of a collision-free path around the obstacle 60 keeping a minimum distance of the robot device to the obstacle 60, a collision-free movement of the robot device with itself, a minimized distance of the curve 21 to the obstacle 60, a minimized length of the geometric path 10, a defined cycle-time or a predefined energy consumption of the robot device, an optimal robot speed, an optimal robot acceleration, a defined and optimal force or torque of the robot device in joint-space or Cartesian space.

FIGS. 2a-2d illustrate a schematic example of finding an optimal blending zone for a robot device along a given path in an iterative manner according to a method of the present invention. To prevent repetitions, for steps of the method performed in an iterative manner, it is referred to the previous section.

FIG. 2a shows a geometric path 10 that is predefined with via points T1, T2, T3 and T4 along an obstacle 60. In via point T2, a target position point 2 and in via point T3, a target position point 3 are indicated as an example. In FIG. 2a, no optimized blending zone has yet been found, as the process is about to be started. The geometric path 10 consists of a first segment 11, 14 and a second segment 12, 15. The first segment 11 and the second segment 12 meet or intersect in the via point T2. The first segment 14 and the second segment 15 meet or intersect in the via point T3.

FIG. 2b shows the first iteration step of the method 100: A first blending zone 20 around the target position point 2 is defined. The first blending zone 20 is defined as a curve 21 of the geometric path 10 that blends the first segment 11 into the second segment 12. The size of the curve 21 is defined by a start position of a start point 23 on the first segment 11 of the geometric path 10 and a curve end position of an end point 25 of the second segment 12 of the geometric path 10.

For the via point T3 with target position point 3, a second blending zone 30 (see FIG. 2d) is generated. The second blending zone 30 is defined as a curve of the geometric path 10 that blends the first segment 14 into the second segment 15 of the geometric path 10. The size of the curve is defined by a start position of a start point 31 on the first segment 14 of the geometric path 10 and a curve end position of an end point 33 of the second segment 15 of the geometric path 10 (see FIG. 2d).

FIG. 2c shows the second iteration step of the method 100 in regard of the first blending zone 20: The size of the first blending zone 20 is optimized by shifting the start point 23 along the first segment 11 and the end point 25 along the second segment 12 of the geometric path 10 to find an optimal blending zone of the at least first blending zone 20. The optimal blending zone for the embodiment of FIG. 2c is the shortcut path 27.

FIG. 2d shows the third iteration step of the method 100. For the first blending zone 20, shifting the start point 23 and the end point 25 along the corresponding segments of the path 10 results in the optimal shortcut path 28 or optimal blending zone for the first blending zone 20.

The optimal blending zone corresponds to a best cost function according to a defined criterion between the curve start point 23 of the first segment 11 and the curve end point 25 of the second segment 12 on the geometric path 10, wherein the optimal blending zone of the at least first blending zone 20 satisfies at least one predefined condition as stated above in detail. One predefined condition could be a collision-free movement of the robot device around or along the obstacle 60 with a minimum distance of the robot device to the obstacle 60.

For the second blending zone 30, shifting the start point 31 and the end point 33 along the corresponding segments of the path 10 results in another optimal shortcut path that is close the obstacle 60. A further optimization is not possible in this scenario when the predefined condition is a collision-free movement of the robot device around the obstacle. Hence, the optimal zone parameter for the second blending zone 30 has finally be found.

The method described in the present disclosure is based on the following assumptions. First, robot links, robot attachments (e.g., tooling), and the surrounding of the robot, e.g. obstacles, are modelled in some way to allow for checking collision status of the robot at a given configuration. Such models can be generated for example from CAD models in a RobotStudio simulation or from point-clouds from a perception system. Second, the obstacle does not move while the robot device is executing the motion.

Given the above assumptions one can check for collisions along a geometric path. The path can be in joint space or Cartesian space.

The input path to the zone parametrization algorithm is a set of joint or Cartesian space targets and the desired interpolation method between these via points. Given the input or defined geometric path, the collision checking functionalities, and availability of kinematics mappings and zone interpolation functions of the robot, the zones for all the via points are enlarged until either a collision is found in a certain via point, or the maximum zone parameter allowed for a target is reached (see FIG. 2). Preferably, the search is performed in a breadth-first manner. If the search is performed in a depth-first manner, when the targets are too close, an earlier target can reach a large blending zone size leaving little room for the enlargement of the subsequent target. The algorithm also prevents blending zone sizes from resulting in overlapping situations between subsequent targets. One realization is for the algorithm to aim at reaching maximum zone sizes which is equivalent to minimizing path length.

However, any other criterion (cycle-time, energy, etc.) that might be affected by blending zone parameters can be used instead in the search as a “cost”. The search can be implemented as a discrete search with fixed or variable step or any other search approach. Automatic collision-free zone parametrization as provided by the method of the present invention can use the full potential of zones for non-productive motions with little effort from the user in offline programming, where the robot cell is already modelled. However, the method of the present invention may also be applied to online scenarios.

According to an example, the first blending zone is a non-linear function that generates a curve in a joint space or in a Cartesian space. The advantage achieved is the efficient performance of the robot device. According to an example, optimizing is performed in an iterative manner. The advantage achieved is that an optimal blending zone can be found in an efficient manner. According to an example, the best cost function according to the defined criterion is the shortest path between the curve start point and the end point. The advantage achieved is that an optimal path of the robot device can be generated in an efficient manner.

According to an example, the at least one predefined condition is at least one of a collision-free path around the obstacle keeping a minimum distance of the robot device to the obstacle, a collision-free movement of the robot device with itself, a minimized distance of the curve to the obstacle, a minimized length of the geometric path, a defined cycle-time or a predefined energy consumption of the robot device. The advantage achieved is that the performance of the robot device can be optimized in an efficient manner and adapted to a changing technical environment or changing requirements to the robot device.

According to an example, the step of optimizing is performed by a discrete search or a continuous search manner. The advantage achieved is to find an optimal blending zone for the robot device in an efficient manner.

According to an example, the step of optimizing is performed by using a machine learning model. The advantage achieved is to find an optimal blending zone for the robot device in an efficient manner.

In a second aspect of the present disclosure, a computer is provided comprising a processor configured to perform the method of the preceding aspect.

In a third aspect of the present disclosure, there is provided a computer program product comprising instructions which, when the program is executed by a processor of a computer, causes the computer to perform the method of any of the first and second aspects.

In a fourth aspect of the present disclosure, a machine-readable data medium and/or download product containing the computer program of the third aspect.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and “at least one” and similar referents in the context of describing the invention (especially in the context of the following claims) are to be construed to cover both the singular and the plural, unless otherwise indicated herein or clearly contradicted by context. The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

### LIST OF REFERENCE SYMBOLS

100 Method
102 Providing
104 Defining
106 Optimizing
2, 3 Target position point
10 Geometric path
11, 14 First segment
12, 15 Second segment
20 First blending zone
21 Curve
30 Second blending zone
23, 31 Start point
25, 33 End point
27, 28 Shortcut path
60 Obstacle

What is claimed is:

1. A method for optimizing a geometric path for a robot device around an obstacle, comprising:
providing the geometric path for the robot device, wherein the geometric path comprises at least one target position point for the robot device that is defined as an intersection of a first segment and a second segment forming the geometric path;
defining at least a first blending zone around the at least one target position point, wherein the at least first blending zone is defined as a curve of the geometric path that blends the first segment into the second segment, and wherein a size of the curve is defined by a start position of a start point on the first segment of the geometric path and a curve end position of an end point of the second segment of the geometric path; and
optimizing the size of the at least first blending zone by shifting the start point along the first segment and the end point along the second segment to find an optimal blending zone of the at least first blending zone that corresponds to a best cost function according to a defined criterion between the curve start point of the first segment and the curve end point of the second segment on the geometric path, wherein the optimal blending zone of the at least first blending zone satisfies at least one predefined condition.

2. The method of claim 1, wherein the at least first blending zone is a non-linear function that generates a curve in a joint space or in a Cartesian space.

3. The method of claim 1, wherein optimizing is performed in an iterative manner.

4. The method of claim 1, wherein the best cost function according to the defined criterion is a shortest path between the curve start point and the end point.

5. The method of claim 1, wherein the at least predefined condition is at least one of a collision-free path around the obstacle keeping a minimum distance of the robot device to the obstacle, a collision-free movement of the robot device with itself, a minimized distance of the curve to the obstacle, a minimized length of the geometric path, a defined cycle-time or a predefined energy consumption of the robot device.

6. The method of claim 1, wherein optimizing is performed by a discrete search or a continuous search manner.

7. The method of claim 1, wherein optimizing is performed by using a machine learning model.

8. A computer program product comprising instructions which, when the computer program is executed by a processor of a computer, causes the computer to perform a method for optimizing a geometric path for a robot device around an obstacle, comprising:
instructions for providing the geometric path for the robot device, wherein the geometric path comprises at least one target position point for the robot device that is defined as an intersection of a first segment and a second segment forming the geometric path;
instructions for defining at least a first blending zone around the at least one target position point, wherein the at least first blending zone is defined as a curve of the geometric path that blends the first segment into the second segment, and wherein a size of the curve is defined by a start position of a start point on the first segment of the geometric path and a curve end position of an end point of the second segment of the geometric path; and
instructions for optimizing the size of the at least first blending zone by shifting the start point along the first segment and the end point along the second segment to find an optimal blending zone of the at least first blending zone that corresponds to a best cost function according to a defined criterion between the curve start point of the first segment and the curve end point of the second segment on the geometric path, wherein the optimal blending zone of the at least first blending zone satisfies at least one predefined condition.

9. The computer program product of claim 8, wherein the at least first blending zone is a non-linear function that generates a curve in a joint space or in a Cartesian space.

10. The computer program product of claim 8, wherein optimizing is performed in an iterative manner.

11. The computer program product of claim 8, wherein the best cost function according to the defined criterion is a shortest path between the curve start point and the end point.

12. The computer program product of claim 8, wherein the at least predefined condition is at least one of a collision-free path around the obstacle keeping a minimum distance of the robot device to the obstacle, a collision-free movement of the robot device with itself, a minimized distance of the curve to the obstacle, a minimized length of the geometric path, a defined cycle-time or a predefined energy consumption of the robot device.

13. The computer program product of claim 8, wherein optimizing is performed by a discrete search or a continuous search manner.

14. The computer program product of claim 8, wherein optimizing is performed by using a machine learning model.
